(19) United States
(12) Patent Application Publication
(10) Pub. No.: US 2025/0123119 A1
(43) Pub. Date: Apr. 17, 2025

(54) FEATURE FUSION OF SENSOR DATA

(71) Applicant: Torc Robotics, Inc., Blacksburge, VA (US)

(72) Inventor: Daniel Moodie, Blacksburg, VA (US)

(21) Appl. No.: 18/485,195

(22) Filed: Oct. 11, 2023

(51) Int. Cl. G01C 21/00; G01C 21/32; G06N 3/0464

(52) U.S. Cl. CPC G01C 21/3844; G01C 21/32; G01C 21/3867; G06N 3/0464

(57) ABSTRACT

In one aspect, a method of fusing sensor data from a plurality of sensors is provided. The method comprises identifying first and second sensor data from first and second sensors of the plurality of sensors, respectively, extracting first and second features from the first and second sensor data, respectively, and converting the first and second features to first and second BEV projections of the first and second features, respectively. The method further comprises implementing a spatial transform network that aligns the second BEV projection with the first BEV projection, and generating a fused feature map comprising the aligned second BEV projection and the first BEV projection.

### TECHNICAL FIELD

The field of the disclosure relates to perception technologies and, more specifically, to combining multiple sensors for improved bird's eye view (BEV) vision that may be used, for example, in autonomous vehicles.

### BACKGROUND OF THE INVENTION

Autonomous vehicles use perception technologies to sense and process their surroundings. Perception technologies can take many forms, but sensors such as light detection and ranging sensors (LIDAR) and cameras are some of the most common. Each sensor within an autonomous vehicle independently acquires data about the vehicle's external environment. Once a map is made of the vehicle's environment, the map may be used to determine the path that the vehicle should take to navigate its surroundings.

Since the vehicle's ability to determine its surroundings is limited by the data obtained from the sensors, it is advantageous if the autonomous vehicle can utilize multiple sensors simultaneously. While ample sensor data gives autonomous vehicles the potential to develop high quality mappings of their surroundings, this data must be fused into a cohesive dataset in order to produce a spatially consistent output.

Thus, it would be desirable to improve on the processes used to fuse sensor data from multiple sensors.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a feature fusion system for fusing sensor data from a plurality of sensors is provided. The feature fusion system comprises circuitry configured to identify first and second sensor data from first and second sensors of the plurality of sensors, respectively, extract first and second features from the first and second sensor data, respectively, and convert the first and second features to first and second BEV projections of the first and second features, respectively. The circuitry is further configured to implement a spatial transform network (STN) that is configured to align the second BEV projection with the first BEV projection, and generate a fused feature map comprising the aligned second BEV projection and the first BEV projection.

In another aspect, a method of fusing sensor data from a plurality of sensors is provided. The method comprises identifying first and second sensor data from first and second sensors of the plurality of sensors, respectively, extracting first and second features from the first and second sensor data, respectively, and converting the first and second features to first and second BEV projections of the first and second features, respectively. The method further comprises implementing an STN that aligns the second BEV projection with the first BEV projection, and generating a fused feature map comprising the aligned second BEV projection and the first BEV projection.

In another aspect, a feature fusion system for fusing sensor data from a plurality of sensors is provided. The feature fusion system comprises circuitry configured to identify first and second sensor data from first and second sensors of the plurality of sensors, respectively, extract first and second features from the first and second sensor data, respectively, and convert the first and second features to first and second BEV projections of the first and second features, respectively. The circuitry is further configured to implement an STN that is configured to align the second BEV projection with the first BEV projection. The STN comprises an artificial neural network configured to estimate a geometric transformation to align the second BEV projection with the first BEV projection, and a differentiable warping function that is configured to transform the second BEV projection based on the geometric transformation. The circuitry is further configured to compare the first BEV projection with the aligned second BEV projection to identify a difference, and to re-train the artificial neural network of the STN based on the difference.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts an autonomous vehicle that utilizes a feature fusion system for fusing sensor data from a plurality of sensors in an exemplary embodiment.

FIG. 2 depicts block diagram of the feature fusion system of FIG. 1 in an exemplary embodiment.

FIG. 3 depicts a flow chart of a method of fusing data from a plurality of sensors in an exemplary embodiment.

FIG. 4 depicts a process flow for self-supervised training of a machine learning network for fusing sensor data in an exemplary embodiment.

FIG. 5 depicts a process flow for utilizing the machine learning network optimized by the self-supervised training of FIG. 4 in an exemplary embodiment.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

In the present disclosure, various embodiments are disclosed that enable data from multiple object detection sensors to be fused together to form a cohesive and globally consistent mapping. For example, an autonomous vehicle can generate an accurate bird's eye view (BEV) projected fused mapping of all of the data from several camera and LIDAR systems. A BEV is an elevated view of an object or location from, for example, a steep viewing angle, which creates a perspective as if the observer were a bird in flight looking downwards.

The BEV is a reference frame that provides viewers a perspective in which they see the world from above. This BEV or top-down view is useful for planning a path through obstacles. Path planning teams frequently work in the BEV frame, so a system which takes and receives BEV projected sensor data aligns with the general framework for autonomous vehicle technologies. Additionally, by utilizing STNs to align the BEV projected data, the process is further improved. Accordingly, in the embodiments described herein, systems and a method are disclosed that provide for fusing sensor data from a plurality of sensors in order to generate a fused feature map in the BEV frame.

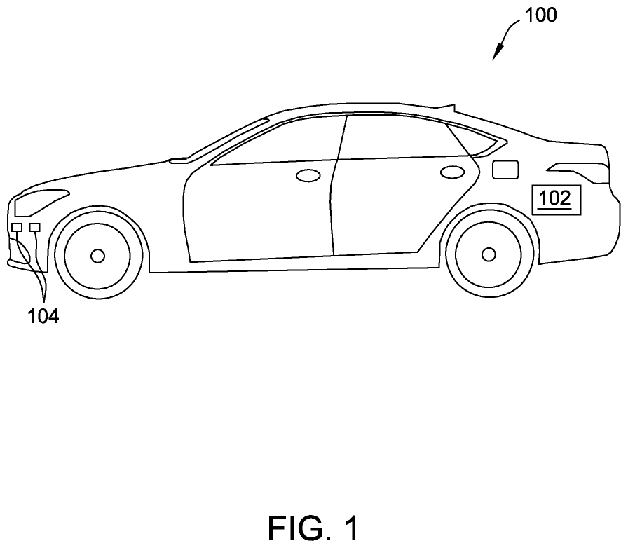

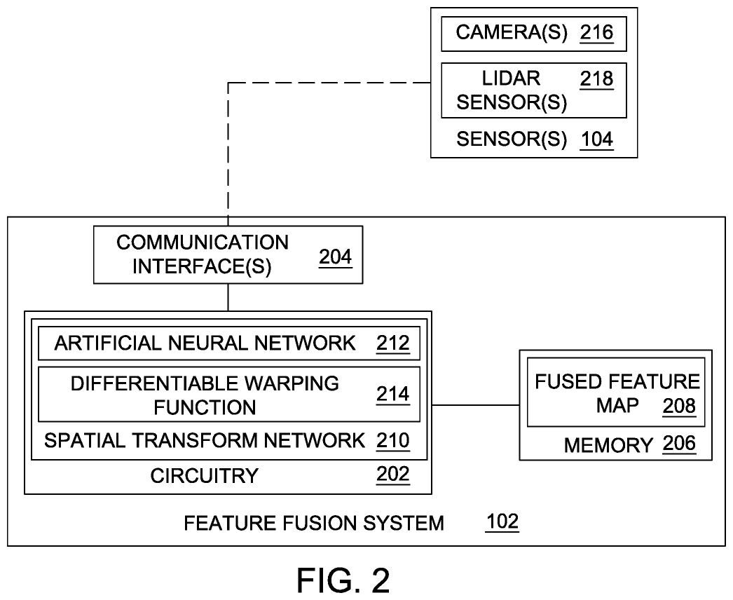

FIG. 1 depicts an autonomous vehicle 100 that utilizes a feature fusion system 102 for fusing sensor data from a plurality of sensors 104, and FIG. 2 depicts block diagram of feature fusion system 102 of FIG. 1, in exemplary embodiments.

In this embodiment, autonomous vehicle 100 utilizes sensors 104 to obtain data regarding its surroundings, and feature fusions system 102 operates to fuse the data from sensors 104 into a cohesive dataset that can be used by autonomous vehicle 100 to, for example, navigate autonomously through its environment.

In this embodiment, and with reference to FIG. 2, feature fusion system 102 comprises circuitry 202, one or more communication interfaces 204, and a memory 206. In this embodiment, feature fusion system 102 receives sensor data from sensors 104 as an input and outputs a fused feature map 208, which is aligned set of data from sensors 104. In this embodiment, circuitry 202 implements one or more STNs 110, which will be described in more detail below.

In this embodiment, sensors 104 may comprise one or more cameras 216, one or more LIDAR sensors 218, other types of sensors, not shown, and combinations thereof. Communication interfaces 204 may comprise wired interfaces (e.g., serial, parallel, Ethernet), wireless interfaces (e.g., Wi-Fi, cellular, Bluetooth), and combinations thereof. Communication interfaces 204 may be used, for example, to receive sensor data from sensors 104, such as images from cameras 216 and/or point cloud data from LIDAR sensors 218. Communication interfaces 204 may also be used to communicate with external systems and devices, not shown, in order to coordinate and implement the functionality described herein for feature fusion system 102.

In the embodiments described herein, feature fusion system 102 comprises any component, system, or device that performs the functionality described herein for processing and aligning data from sensors 104 in order to generate fused feature map 208. Feature fusion system 102 will be described with respect to various discrete elements, which perform functions. These elements may be combined with respect to various discrete embodiments or segmented into different discrete elements in other embodiments. Additionally, some embodiments may comprise an array of cameras 216 and LIDAR sensors 218 all working on detecting features in the same area. Other embodiments may comprise a variety of sensors 104 that are neither cameras nor LIDAR systems.

In some embodiments, feature fusion system 102 may filter or modify the raw sensor data into a more useful form before passing that data to circuitry 202. This modification may comprise a range of signal processing techniques, working individually or cohesively. The modification can be used to improve the quality of input sensor data or to put the sensor data into a form that is easier and/or more efficient for circuitry 202 to use. After circuitry 202 identifies the sensor data from sensors 104, circuitry 202 extracts the features from the sensor data and converts the features into a BEV projection of the features.

In some embodiments, circuitry 202 is configured to convert the features to the BEV projection using geometric transformations. In these embodiments, the geometric transformations may stem from code programmed directly into a processor, which may be implemented by circuitry 202 in some embodiments. However, the geometric transformations may be called from an external program which is used to convert the features into BEV projections of the features that is represented in two-dimensional space. However, the two-dimensional representation may or may not also include information stored in the form of a temperature or color mapping, which indicates the height of objects or features in the two-dimensional representation as a function of their relative position. In this embodiment, the BEV representation is two-dimensional in appearance but functions as both a two-dimensional and a three-dimensional mapping.

As discussed briefly above, circuitry 202 is further configured to implement STN 210 in this embodiment. STN 210 may comprise, for example, an artificial neural network 212 that estimates geometric transformations and a differentiable warping function 214 that transforms sensor data generated by sensors 104 based on the estimated transform. STN 210 is configured to align features in the sensor data generated by sensors 104 to generate fused feature map 208. STN 210 is a type of machine-learning system. Machine learning systems typically use artificial neural networks, such as artificial neural network 212. Artificial neural networks are layers of weighted nodes with varying degrees of connectedness. In order to find and define relationships between data points, these nodes may use convolutions (products). These convolutional neural networks are an example of deep learning. While convolutional neural networks are exceptionally useful, their results are not inherently spatially invariant. To produce a spatially invariant outcome, STN 210 may be used.

In this embodiment, STN 210 takes in the BEV projected features from sensors 104 and then identifies pairs of data points that STN 210 predicts depict the same features in the sensor data. After STN 210 has determined that these two data points depict the same feature, STN 210 utilizes artificial neural network 212 to estimate the spatial transformations necessary to align these components of the data. Once artificial neural network 212 has estimated the transformations necessary to align a sufficient number of pairs of data points, differentiable warping function 214 implements the transformations to generate fused feature map 208, which is an aligned BEV projection of the features in the sensor data from sensors 104.

In some embodiments, STN 210 may utilize continuous convolutional neural networks. The BEV projected sensor data can be presented in either a continuous or discrete format to STN 210. If the BEV projected sensor data is discrete, then continuous convolutional neural networks may not be necessary. However, if the BEV projected sensor data is provided to STN 210 in a continuous manner, then continuous convolutional neural networks may be used to continuously evaluate the sensor data. Continuous convolutional neural networks have the benefit that they may provide increased sensitivity. Increased sensitivity would allow STN 210 to output more accurate calibration data. However, this increased sensitivity may cause STN 210 to be more computationally expensive. Some embodiments may prefer greater accuracy at the expense of increased computational costs, while other embodiments may prefer lower accuracy with the added benefit of lower computational costs.

In this embodiment, circuitry 202 is further configured to extract features from the sensor data. In some embodiments, circuitry 202 is configured to extract features from the sensor data using one or more convolutional networks. Once the features are extracted from the sensor data, circuitry 202 converts the features to BEV projections of the features, STN 210 aligns the BEV projections, and circuitry 202 generates fused feature map 208.

Fused feature map 208 may be created in the BEV. However, fused feature map 208 may be created in another reference frame. In some embodiments, fused feature map 208 may be created in one reference frame and projected into multiple other reference frames to assist with multiple tasks in the optimal frame for each task. Fused feature map 208 may represent a spatial region proximate to sensors 104. However, fused feature map 208 may represent a spatial region some distance from sensors 104. It may be beneficial to have sensors 104 detect objects nearby since sensors 104 will detect closer objects to a higher degree of accuracy. Yet, as autonomous vehicle 100 is capable of travelling at high speeds, it is also desirable to locate features in the environment that autonomous vehicle 100 will encounter in the near future. Therefore, in some embodiments, feature fusion system 102 may detect features at a significant distance in front of, and/or to the side of (depending on the future trajectory), autonomous vehicle 100.

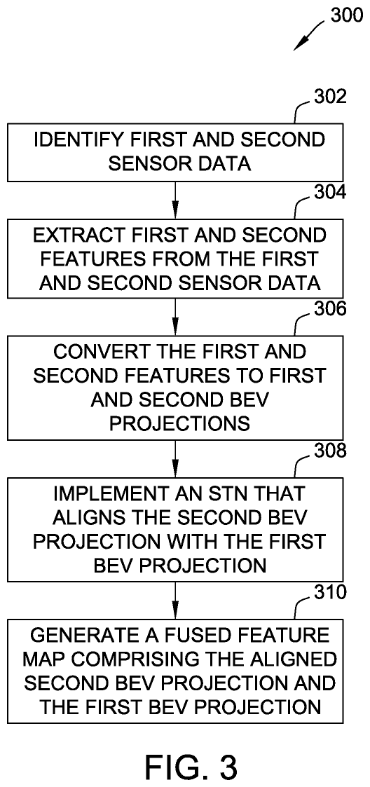

FIG. 3 depicts a flow chart of a method 300 for fusing sensor data from a plurality of sensors in an exemplary embodiment. Method 300 will be discussed with respect to feature fusion system 102 of FIGS. 1 and 2, although method 300 may be performed by other systems, not shown.

In this embodiment, method 300 comprises identifying 302 first and second sensor data from first and second sensors of the plurality of sensors, respectively. For example, circuitry 202 identifies the first and second sensor data from sensors 104. The sensor data obtained may be raw data sent directly from sensors 104. However, in some embodiments the sensor data may be filtered or modified before being processed by circuitry 202. The sensor data may also represent a single region of space or a set of regions of space. The sensor data may be received in either a two-dimensional or three-dimensional representation of the sensor data. In some embodiments, the sensor data may be in the form a signal which is obtained from sensors 104.

Method 300 further comprises extracting 304 first and second features from the first and second sensor data. For example, circuitry 202 utilizes one or more neural networks, not shown, (e.g., convolutional neural networks) to extract the features from the data generated by the first and second sensors.

Method 300 further comprises converting 306 the first and second features to first and second BEV projections. For example, circuitry 202 converts the first and second features to first and second BEV projections. The features may be projected into the BEV by a series of geometric transformations. In some embodiments, the features may be projected into the BEV by a transformation package. In other embodiments, the features may be projected by different mechanisms for each type of sensor 104, or for each sensor 104 individually.

Method 300 further comprises implementing 308 an STN that is configured to align the second BEV projection with the first BEV projection. For example, circuitry 202 implements STN 210, and STN 210 aligns the second BEV projection with the first BEV projection. In another example, artificial neural network 212 analyzes the first and second BEV projections, and generates one or more geometric transforms to align the second BEV projection with the first BEV projection. Differentiable warping function 214 may then implement the one or more geometric transformations generated by artificial neural network 212 in order to align the second BEV projection with the first BEV projection.

Method 300 further comprises generating 310 fused feature map 208 comprising the aligned second BEV projection and the first BEV projection. For example, differentiable warping function 214 generates fused feature map 208, which is an aligned BEV projection of the features captured by the first and second sensors.

In some embodiments, the circuitry is further configured to compare the first BEV projection with the aligned second BEV projection to identify a difference, and re-train an artificial neural network of the STN based on the difference. For example, circuitry 202 may compare the first BEV projection with the aligned second BEV projection to identify the difference, and re-train artificial neural network 212 based on the difference. Re-training artificial neural network 212 based on the difference improves the performance of artificial neural network 212 in generating the one or more geometric transformations used by differentiable warping function 214 to align the second BEV projection with the first BEV projection. For example, circuitry 202 may compare the first BEV projection of the first features from the first sensor to the aligned second BEV projection of the second features from the second senor using a L1 reconstruction loss as well as a structural similarity index measure (SSIM). The L1 reconstruction loss quantifies the quality of the alignment between the first and second BEV projections of the first and second features, while the SSIM qualifies how well the edges align between the first and second BEV projections of the first and second features. These losses compare the two BEV projections and score the alignment between them. The alignment score may then be used as a guiding function for re-training artificial neural network 212.

In some embodiments, the fused feature map represents a spatial region proximate to the feature fusions system, and the circuitry is further configured to determine, utilizing the fused feature map, a path through the spatial region. For example, fused feature map 208 may represent a spatial region proximate to autonomous vehicle 100, and circuitry 202 determines, utilizing fused feature map 208, a path for autonomous vehicle 100 through the spatial region.

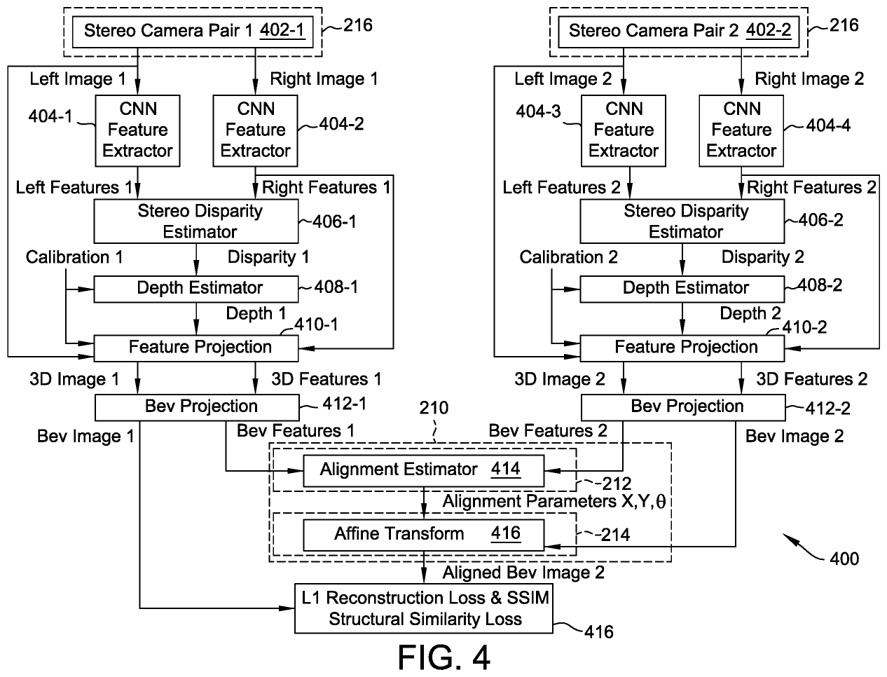

FIG. 4 depicts a process flow 400 for self-supervised training of a machine learning network in an exemplary embodiment. In this embodiment, process flow 400 depicts the use of stereo camera pairs 402, although process flow 400 may utilize other types of sensors and/or other combinations of sensors in other embodiments. In this embodiments, stereo camera pairs 402 have partially overlapping fields of view, both with each other and between each camera 216 in each of stereo camera pairs 402. In process flow 400, the left and right image data from stereo camera pairs 402 are provided to CNN feature extractors 404, which extract feature data from the images. In particular, left and right image data from a first stereo camera pair 402-1 is provided to first and second CNN feature extractors 404-1, 404-2, respectively, and left and right image data from a second stereo camera pair 402-2 is provided to third and fourth CNN feature extractors 404-3, 404-4, respectively. CNN feature extractors 404 utilize convolutional neural networks to extract features from the image data generated by stereo camera pairs 402.

The output of CNN feature extractors 404 is provided to stereo disparity estimators 406, which estimate the per pixel disparity between the left and right images for each stereo camera pair 402. For example, stereo disparity estimators 406 estimate the pixel shift of the same object or feature between the left and right images for each of the stereo camera pairs 402. In particular, left and right features from first and second CNN feature extractors 404-1, 404-2 are provided to a first stereo disparity estimator 406-1, and left and right features from third and fourth CNN feature extractors 404-3, 404-4 are provided to a second stereo disparity estimator 406-2. Stereo disparity estimators 406 may comprise neural networks that vary based on the type of object being detected.

The estimated disparity for each stereo camera pair 402 is provided to a depth estimator 408, which uses a known calibration to convert the disparity to a depth. In process flow 400, a first depth estimator 408-1 uses a first calibration of first stereo camera pair 402-1 (e.g., a distance or other type of spatial relationship such as roll or pitch between cameras 216 of first stereo camera pair 402-1), and a second depth estimate 408-2 uses a second calibration of second stereo camera pair 402-2 (e.g., a distance or other type of spatial relationship such as roll or pitch between cameras 216 of second stereo camera pair 402-2). The first and second calibration may also include information regarding the spatial relationship such as roll, pitch, and/or distance between the first and second stereo camera pairs 402.

At this point in process flow 400, for each pixel in the left images of stereo camera pairs 402 we have (1) unprocessed images; (2) extracted image features; and (3) depth estimates.

Features may then be ray cast into the environment using camera geometry and the estimated depth to create a 3D point cloud of high dimensional feature information, via a first feature projection 410-1 associated with first stereo camera pair 402-1 and a second feature projection 410-2 associated with second stereo camera pair 402-2. Additionally, the same process may be applied to the unprocessed images to create an RGB point cloud. The 3D features may then be projected onto the BEV plane via a first BEV projection 412-1 associated with first stereo camera pair 402-1, which outputs first BEV features, and a second BEV projection 412-2 associated with second stereo camera pair 402-2, which outputs second BEV features. Similarity, the unprocessed image is projected onto the BEV plane. The technique disclosed for process flow 400 implements point splatting. Up to this point in process flow 400, the same process has been applied to both stereo camera pairs 402. Generally, in order to perform the BEV projection, once the 3D features are in the form of points with XYZ coordinates, a projection function is applied in order to find the coordinates of the projection onto the BEV plane. Using this information, a discretized BEV representation is populated using point spatting to fill a BEV image with values from the 3D features.

The following discussion is often referred to as an STN, since it is a network that estimates a spatial transform and then applies the spatial transform to the data for further processing. In this embodiment, STN 210 includes an alignment estimator 414, which is implemented by artificial neural network 212, and an affine transform 416, which is implemented by differentiable warping function 214 (see FIG. 2). The information between stereo camera pairs 402 is provided to alignment estimator 414, and alignment estimator 414 operates on the first and second BEV features and estimates or generates affine transform 416, which will bring the features into alignment with each other. In process flow 400, affine transform 416 is applied to the second BEV image from second stereo camera pair 402-2 to bring it into alignment with the first BEV image of first stereo camera pair 402-1.

The first BEV image may then be compared to the aligned second BEV image using a L1 reconstruction loss as well as a structural similarity index measure (SSIM). The L1 reconstruction loss quantifies the quality of the alignment between the first and second BEV images, while the SSIM qualifies how well the edges align between the first and second BEV images. These losses compare the two images and score the alignment between them. The alignment score may then be used as a guiding function for optimizing alignment estimator 414 in order to improve the performance of estimating or generating affine transform 416.

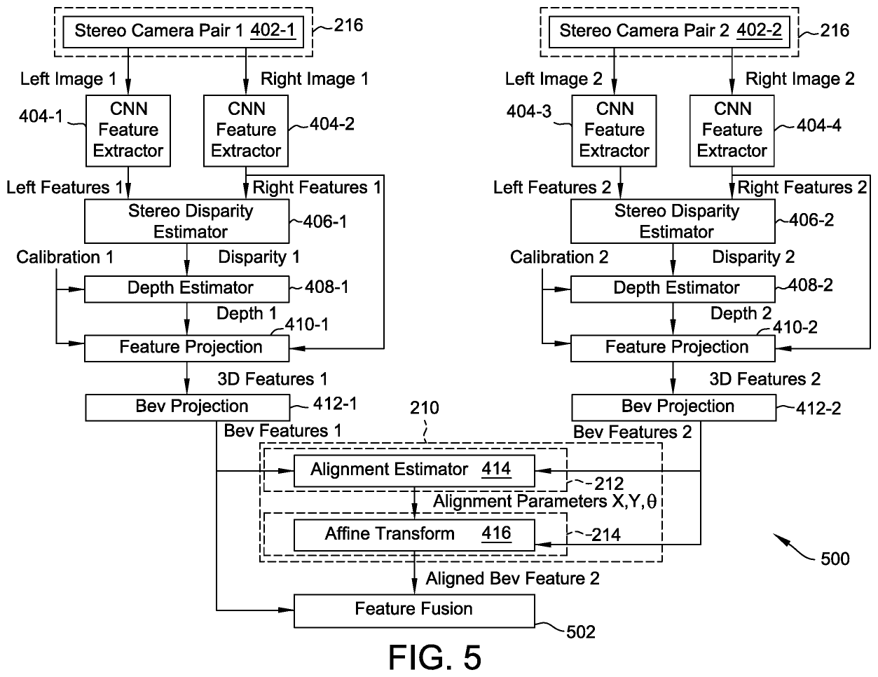

FIG. 5 depicts a process flow 500 for utilizing the machine learning network optimized by the self-supervised training of FIG. 4 in an exemplary embodiment. In process flow 500, instead of aligning images, affine transform 416 is used to align second BEV projection 412-2 of features captured by second stereo camera pair 402-2 with first BEV projection 412-1 of features captured by first stereo camera pair 402-1. Feature fusion 502 of the first BEV features of first stereo camera pair 402-1 and the aligned BEV features of second stereo camera pair 402-2 is the result of performing process flow 500, resulting in fused feature map 208 (see FIG. 2)

In some embodiments of process flows 400 and 500, stereo camera pairs 402 may be replaced with monocular cameras, and rather than using stereo techniques to estimate depth via depth estimators 408, a monocular distance estimation neural network may be used.

In other embodiments of process flows 400 and 500, rather than using a discrete BEV representation, a continuous representation may be used, and continuous convolutions may then be used by alignment estimators 414.

In other embodiments of process flows 400 and 500, cross modality alignment may be achieved by using the BEV plane as a common reference frame, which may modify the training process depicted in process flow 400 as image loss reconstruction may not work across modalities. Image loss reconstruction may not work across modalities since LIDAR representations may not match. However, in some embodiments, a comparison between a LIDAR point cloud and an image based point cloud may be performed, and the comparison may be based on the geometric information extracted from the data rather than the visual information in the data.

In other embodiments of process flows 400 and 500, multi-camera fusion may be achieved at inference time by having a global optimizer that optimizes affine transform 416 between each camera pair. To implement a global calibration correction, a global optimizer may be inserted between an STN (e.g., STN 210) that estimates a pairwise calibration correction, and a warping function (e.g., differentiable warping function 214) that applies the corrections to the data. The global optimizer may then create new pairwise calibration corrections based on a common objective function.

Although process flows 400 and 500 have been described with respect to sensor data generated by cameras 216, process flows 400 and 500 may be utilized to process sensor data from other types of sensors 104, such as LIDAR sensors 218. As LIDAR sensors generate point cloud data that may include distance information to features in the environment, embodiments of process flows 400 and 500 that utilize LIDAR sensors 218 may not implement stereo disparity estimators 406 and depth estimators 408.

An example technical effect of the embodiments described herein includes at least one of: (a) improving the performance of fusing sensor data to generate a fused feature map utilizing BEV projections, STNs, and (b) training, applying, and re-training artificial neural networks of STNs.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A feature fusion system for fusing sensor data from a plurality of sensors, the feature fusion system comprising:
circuitry configured to:
identify first and second sensor data from first and second sensors of the plurality of sensors, respectively;
extract first and second features from the first and second sensor data, respectively;
convert the first and second features to first and second bird's eye view (BEV) projections of the first and second features, respectively;
implement a spatial transform network (STN) that is configured to align the second BEV projection with the first BEV projection; and
generate a fused feature map comprising the aligned second BEV projection and the first BEV projection.

2. The feature fusion system of claim 1, wherein:
the STN comprises:
an artificial neural network configured to estimate a geometric transformation to align the second BEV projection with the first BEV projection; and
a differentiable warping function configured to transform the second BEV projection based on the geometric transformation.

3. The feature fusion system of claim 2, wherein:
the circuitry is further configured to:
compare the first BEV projection with the aligned second BEV projection to identify a difference; and
re-train the artificial neural network of the STN based on the difference.

4. The feature fusion system of claim 1, wherein:
the fused feature map represents a spatial region proximate to the feature fusion system, and
the circuitry is further configured to determine, utilizing the fused feature map, a path through the spatial region.

5. The feature fusion system of claim 1, wherein:
the circuitry is further configured to extract the first and second features from the first and second sensor data utilizing one or more convolutional neural networks.

6. The feature fusion system of claim 1, wherein:
the first and second BEV projections are represented in two-dimensional space.

7. The feature fusion system of claim 1, wherein:
the first and second sensors each comprise a pair of sensors.

8. The feature fusion system of claim 1, wherein:
the first and second sensors comprise cameras and/or light detection and ranging (LIDAR) sensors.

9. A method of fusing sensor data from a plurality of sensors, the method comprising:
identifying first and second sensor data from first and second sensors of the plurality of sensors, respectively;
extracting first and second features from the first and second sensor data, respectively;
converting the first and second features to first and second bird's eye view (BEV) projections of the first and second features, respectively;
implementing a spatial transform network (STN) that aligns the second BEV projection with the first BEV projection; and
generating a fused feature map comprising the aligned second BEV projection and the first BEV projection.

10. The method of claim 9, wherein:
the STN comprises an artificial neural network and a differentiable warping function, and
the method further comprises:
estimating, by the artificial neural network, a geometric transformation to align the second BEV projection with the first BEV projection; and
transforming, by the differentiable warping function, the second BEV projection based on the geometric transformation.

11. The method of claim 10, further comprising:
comparing the first BEV projection with the aligned second BEV projection to identify a difference; and
re-training the artificial neural network of the STN based on the difference.

12. The method of claim 9, wherein:
the fused feature map represents a spatial region proximate to the first and second sensors, and
the method further comprises:
determining, utilizing the fused feature map, a path through the spatial region.

13. The method of claim 9, wherein extracting the first and second features further comprises:
utilizing one or more convolutional neural networks to extract the first and second features from the first and second sensor data.

14. The method of claim 9, wherein:
the first and second BEV projections are represented in two-dimensional space.

15. The method of claim 9, wherein:
the first and second sensors each comprise a pair of sensors.

16. The method of claim 9, wherein:
the first and second sensors comprise cameras and/or light detection and ranging (LiDAR) sensors.

17. A feature fusion system for fusing sensor data from a plurality of sensors, the feature fusion system comprising:
circuitry configured to:
identify first and second sensor data from first and second sensors of the plurality of sensors, respectively;
extract first and second features from the first and second sensor data, respectively;
convert the first and second features to first and second bird's eye view (BEV) projections of the first and second features, respectively;
implement a spatial transform network (STN) that is configured to align the second BEV projection with the first BEV projection, wherein the STN comprises:
an artificial neural network configured to estimate a geometric transformation to align the second BEV projection with the first BEV projection; and
a differentiable warping function configured to transform the second BEV projection based on the geometric transformation; and
compare the first BEV projection with the aligned second BEV projection to identify a difference; and
re-train the artificial neural network of the STN based on the difference.

18. The feature fusion system of claim 17, wherein:
the circuitry is further configured to:
generate a fused feature map comprising the aligned second BEV projection and the first BEV projection.

19. The feature fusion system of claim 18, wherein:
the fused feature map represents a spatial region proximate to the feature fusion system, and
the circuitry is further configured to determine, utilizing the fused feature map, a path through the spatial region.

20. The feature fusion system of claim 17, wherein:
the first and second sensors each comprise a pair of sensors, and
the first and second sensors comprise cameras and/or light detection and ranging (LIDAR) sensors.
